(19) United States
(12) Patent Application Publication
(10) Pub. No.: US 2011/0278859 A1
(43) Pub. Date: Nov. 17, 2011

(54) COOLING HEAT GENERATING EQUIPMENT

(76) Inventors: Charles R. Taylor, Jacksonville, FL (US); Anthony David Hynes, Charlton (GB)

(21) Appl. No.: 12/780,718

(22) Filed: May 14, 2010

(51) Int. Cl. H02K 7/18; F01K 13/00

(52) U.S. Cl. 290/1 R; 60/645

(57) ABSTRACT

In one general embodiment, a system includes a working fluid operable to be circulated through a working cycle. The working cycle includes one or more expander-generators driven by the working fluid to generate electrical power at a first condition; an evaporator heat exchanger; and a condenser heat exchanger. The system includes power electronics thermally coupled to a heat exchanger and adapted to convert the electrical power at the first condition to electrical power at a second condition; and a conduit in fluid communication with the working cycle and the heat exchanger. The conduit is adapted to circulate the working fluid through the heat exchanger such that heat generated by the power electronics is transferred to the working fluid.

### TECHNICAL BACKGROUND

The present disclosure relates to electrical systems that generate heat as part of a power generation operation and cooling systems used to dissipate the generated heat.

### BACKGROUND

Certain power generation systems, such as systems utilizing an organic Rankine cycle to generate electrical power, may use an expansion turbine to produce electrical power from high temperature and pressure refrigerants. The generated power, often generated as high frequency AC power, may subsequently be converted to a useable AC power output by use of a rectifier and an inverter. The conversion of this power from one form to another involves some level of inefficiency that creates heat. This heat is often continuously or periodically dissipated into a heat sink to prevent overheating of sensitive electrical components in the conversion device.

In some instances, heat is removed using either air-cooling with fans to convect the heat away from the heat sink of the electrical conversion device or water flow through the heat sink to conduct the heat away in the water. In either instance, there are design considerations. For example, additional energy may be required in systems that utilize air-cooled heat sinks, such as electrical power for the fans required to push airflow over the heat sink. This causes further inefficiencies in the device. As another example, air drawn through the fans may need to be filtered to prevent clogging of the heat sink or reduction of the cooling flow over the heat sink. This may require significant maintenance to the system to replace filters and clean heat sinks, as well as other maintenance considerations. With respect to systems that use a water-cooled heat sink, a clean water source is typically required but, in some cases, may not always be readily available where the system is sited. If there is no continuous supply of clean water, then a separate system must be set up to circulate and cool the water used to remove the heat from the device. This may add additional expense, both in first cost and maintenance costs, as well as operating costs.

### SUMMARY

In one general embodiment, a system includes a working fluid operable to be circulated through a working cycle. The working cycle includes one or more expander-generators driven by the working fluid to generate electrical power at a first condition; an evaporator heat exchanger; and a condenser heat exchanger. The system includes power electronics thermally coupled to a heat exchanger and adapted to convert the electrical power at the first condition to electrical power at a second condition; and a conduit in fluid communication with the working cycle and the heat exchanger. The conduit is adapted to circulate the working fluid through the heat exchanger such that heat generated by the power electronics is transferred to the working fluid.

In another general embodiment, a method includes circulating a working fluid through a working cycle where the working cycle includes one or more expander-generators driven by the working fluid to generate electrical power at a first condition; an evaporator heat exchanger; and a condenser heat exchanger. The method also includes circulating at least a portion of the working fluid through a conduit in fluid communication with the working cycle and a heat exchanger, where the heat exchanger is thermally coupled to power electronics adapted to convert the electrical power at the first condition to electrical power at a second condition; and transferring heat generated by the power electronics to the portion of the working fluid in the heat exchanger.

In another general embodiment, a method includes generating electrical power with one or more turbine-generators driven by a Rankine cycle fluid; converting the electrical power to a line current being three-phase current at a frequency between approximately 50 Hz and approximately 60 Hz; generating, during the conversion of the electrical power, heat energy; and transferring the heat energy to the fluid.

In one aspect of one or more general embodiments, the working cycle may be a closed thermodynamic cycle.

In one aspect of one or more general embodiments, the closed thermodynamic cycle may be an organic Rankine cycle.

In one aspect of one or more general embodiments, heat transferred to the working fluid in the heat exchanger may be substantially equal to a heat of vaporization of the working fluid.

In one aspect of one or more general embodiments, the working cycle may further include an economizer heat exchanger adapted to facilitate heat transfer between the working fluid exhausted from the one or more expander-generators and the working fluid exiting the condenser heat exchanger.

In one aspect of one or more general embodiments, the working fluid exhausted from the one or more expander-generators may include a vapor and the working fluid exiting the condenser heat exchanger may include a liquid.

In one aspect of one or more general embodiments, the working cycle may further include a pump adapted to circulate the working fluid through at least a portion of the working cycle, and the conduit may be fluidly coupled to the heat exchanger and the working cycle between an outlet of the pump and the economizer and fluidly coupled to the heat exchanger and the working cycle between the economizer and the condenser.

In one aspect of one or more general embodiments, one or more isolation valves may be adapted to fluidly isolate the conduit from the working cycle.

In one aspect of one or more general embodiments, an expansion valve including an actuator may be fluidly coupled to the conduit, where the actuator is adapted to modulate the expansion valve based on the heat generated by the power electronics.

In one aspect of one or more general embodiments, a valve may be fluidly coupled to the conduit, where the valve is adapted to provide a predetermined flow rate of the working fluid through the conduit and to the heat exchanger based on a predetermined amount of heat generated by the power electronics.

In one aspect of one or more general embodiments, the power electronics may include one or more switches, where the switches may be adapted to receive the electrical power at the first condition and convert the electrical power at the first condition to the electrical power at the second condition. The second condition may be three-phase AC power at substantially 60 Hz frequency.

In one aspect of one or more general embodiments, a method may further include circulating a first portion of the working fluid in a vapor phase into a hot side of an economizer; circulating a second portion of the working fluid in a liquid phase into a cold side of the economizer; and transferring heat from the first portion of the working fluid to the second portion of the working fluid.

In one aspect of one or more general embodiments, a method may further include pumping at least some of the working fluid through the working cycle with a pump; circulating, from a location in the working cycle between an outlet of the pump and the cold side of the economizer, the portion of the working fluid through a conduit to the heat exchanger; and circulating the portion of the working fluid through the conduit from the heat exchanger to a location in the working cycle between the hot side of the economizer and the condenser.

In one aspect of one or more general embodiments, a method may further include fluidly isolating the conduit and the heat exchanger from the working cycle.

In one aspect of one or more general embodiments, a method may further include throttling a flow of the portion of the working fluid circulated through the conduit with a valve between an open position and a closed position based on an amount of heat generated by the power electronics.

In one aspect of one or more general embodiments, a method may further include rectifying the electrical power at a first condition from AC power to DC power; and inverting the DC power to electrical power at a second condition, the second condition being three-phase AC power at substantially 60 Hz frequency.

In one aspect of one or more general embodiments, transferring the heat energy to the fluid may include circulating a flow of the fluid to a heat exchanger in thermal communication with one or more electronic switches performing the conversion of the electrical power to the line current; monitoring a property of the fluid at or near the heat exchanger; and modulating the flow of the fluid based on the property exceeding a predetermined value.

In one aspect of one or more general embodiments, a method may further include calculating an amount of the heat energy based on an efficiency of one or more electronic switches performing the conversion of the electrical power to the line current; and circulating a mass flow of the fluid to a heat exchanger in thermal communication with the one or more electronic switches. A heat of vaporization of the mass flow of the fluid may be substantially equal to the calculated amount of heat energy.

Various implementations of a power generation system including a cooling system according to the present disclosure may include one or more of the following features. For example, the system may provide for more efficient (e.g., energy uses, maintenance costs) operating system than typical power generation systems. As another example, the system may be located in or at any number of environments, including environments where water or another cooling liquid is scarce. As another example, the system may be located in or at environments where energy for electronics cooling (e.g., for convective cooling of electronics) is scarce or non-existent. In some instances, the system may allow for substantially stand-alone operation to generated AC power without additional utility services (e.g., water, electricity, steam). In certain instances, the system may provide for AC power generation utilizing waste heat as a power source. For instance, in some embodiments, the system may utilize an organic Rankine cycle to generate AC power. As yet another example, the cooling system may be retrofittable onto existing power generation systems.

These general and specific aspects may be implemented using a device, system or method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIGS. 1A-E illustrate an isometric and four side views of one implementation of a power generation system utilizing a cooling system according to the present disclosure;

FIG. 2 illustrates one example process diagram showing one example operation of a power generation system utilizing a cooling system;

FIG. 3 illustrates another example process diagram showing one example operation of a power generation system utilizing a cooling system; and

FIG. 4 illustrates one example implementation of a heat exchanger for power electronics within a power generation system.

### DETAILED DESCRIPTION

Techniques for cooling heat generating equipment include a cooling system integrated within or to a power generation system generating AC power. In some embodiments, the power generation system includes a working fluid, such as a refrigerant, which circulates through a thermodynamic cycle to drive one or more turbine-generators. The turbine-generators produce AC power at a first condition (i.e., frequency and voltage). Power electronics in the power generation system rectify the first condition to a second condition at a different frequency and/or voltage. The power electronics produce heat during rectification and/or conversion, which may be dissipated into the working fluid through a heat sink. In some embodiments, use of the working fluid to dissipate heat may allow for more efficient and stand alone operation of the power generation system as compared to other systems without affecting the performance of the power generation system.

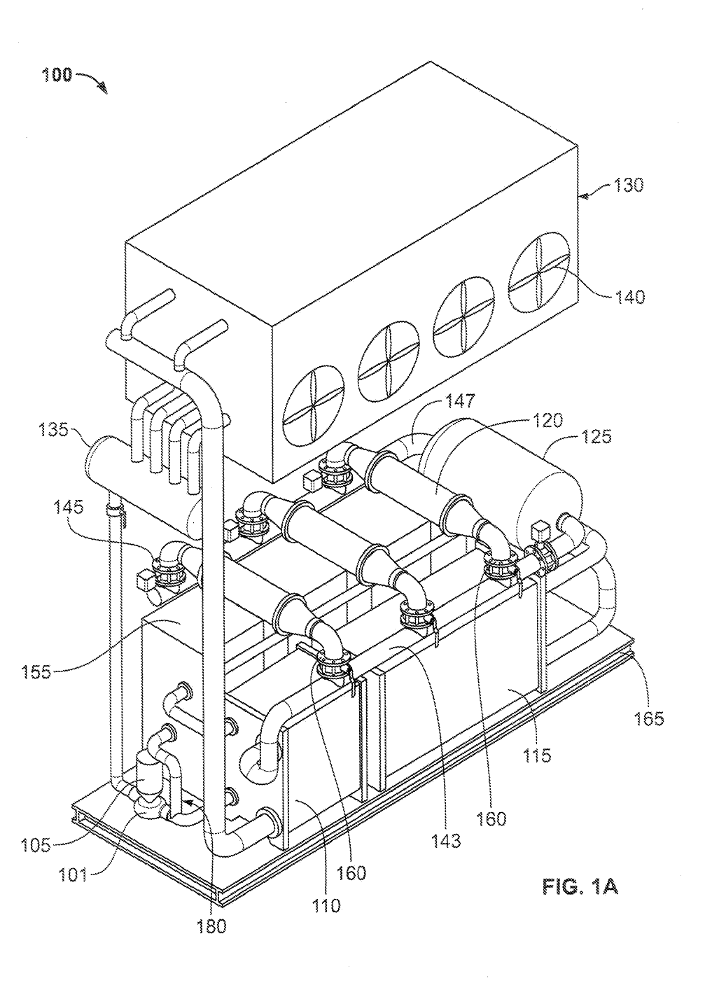

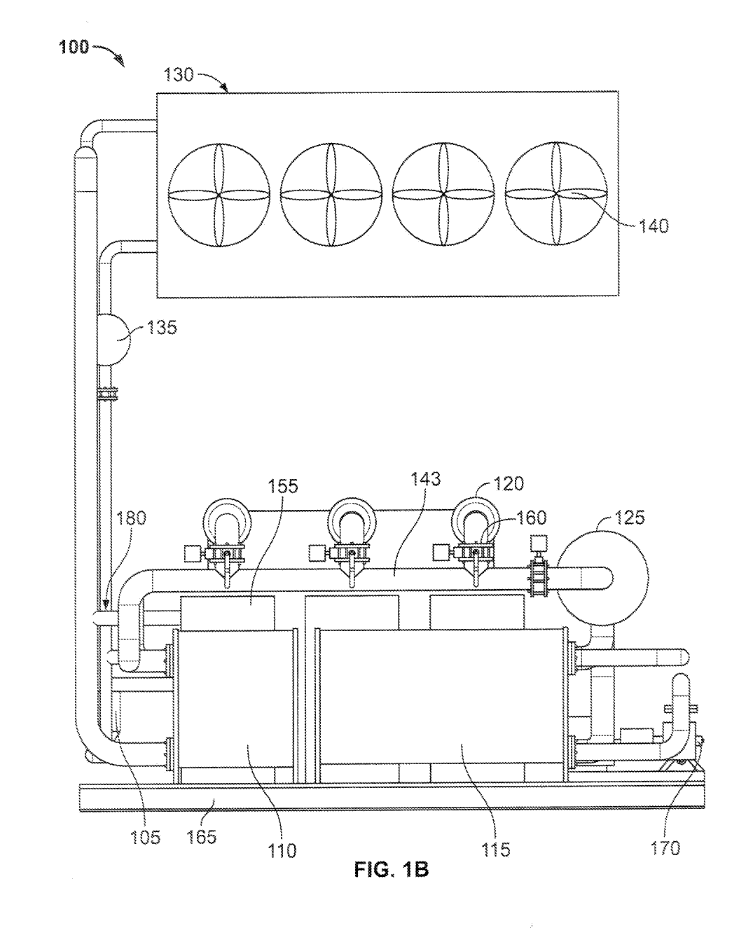

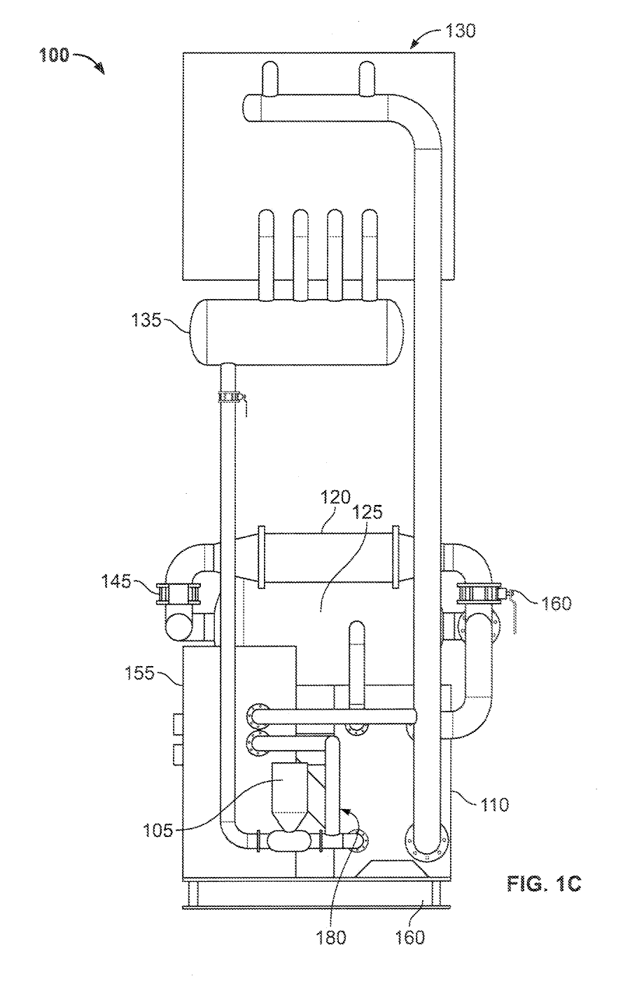

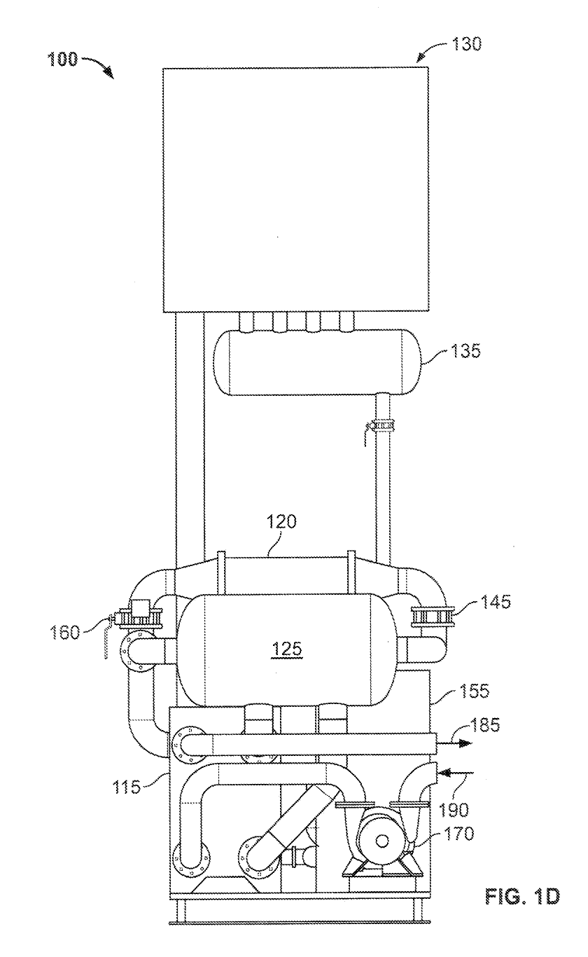

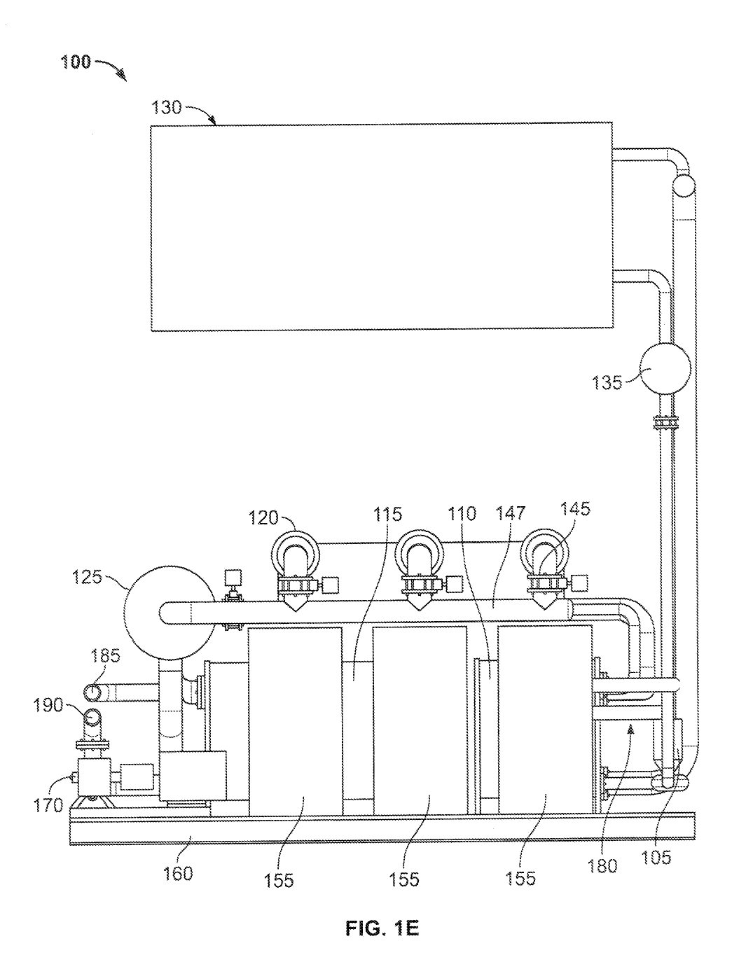

FIGS. 1A-E illustrate an isometric and four side views of one implementation of a power generation system 100 utilizing a cooling system 180. As illustrated, the power generation system 100 utilizes a thermal fluid (e.g., a fluid heated by waste heat, a fluid heated by generated heat, or any other heated fluid) to drive one or more turbine expanders by utilizing a closed (or open) thermodynamic cycle to generate electrical power. The illustrated embodiment 100 includes a working fluid pump 105, an economizer 110, an evaporator 115, one or more turbine expanders 120, a surge vessel 125, a condenser 130, a receiver 135, power electronics 155, and a cooling system 180. Although some components of power generation system 100 are shown as single components, the present disclosure contemplates that each single component may be multiple components performing identical or substantially identical functions (e.g., reference to economizer 110 encompasses references to multiple economizers). Likewise, although some components of power generation system 100 are shown as multiple components, the present disclosure contemplates that multiple, identical components may be a single components performing the identical or substantially identical functions as the multiple components (e.g., reference to turbine expander 120 encompasses reference to a single turbine expander 120). As illustrated, power generation system 100 is mounted on a skid 160. Alternatively, the illustrated components of power generation system 100 may be mounted on several, separate skids, mounted on a substantially immobile structure (e.g., a floor), and/or separated among several locations. Further, power generation system 100 may include additional components not illustrated in FIGS. 1A-E, such as, for example, additional valves, sensors (e.g., pressure, temperature, flow rate), and/or fittings.

Pump 105 pressurizes a working fluid 101 circulating through the thermodynamic cycle utilized by power generation system 100. In some embodiments, the working fluid 101 is a refrigerant (e.g., an HFC, CFC, HCFC, ammonia, water, or other refrigerant), such as, for example, R245fa. As illustrated, an inlet of the pump 105 is fluidly coupled to an outlet of the receiver 135 while an outlet of the pump 105 is fluidly coupled to the economizer 110. Further, as illustrated, the cooling system 180 is positioned at the outlet of the pump 105 (explained in further detail below).

The economizer 110, as illustrated, is a plate and frame heat exchanger that is fluidly coupled with the outlet of the pump 105 and an inlet of the condenser 130. Typically, working fluid 101 at a high temperature and pressure liquid phase from the pump 105 is circulated into one side of the economizer 110 while working fluid 101 at a low temperature and pressure vapor phase (from an exhaust header 143) is circulated into another side of the economizer 110 with the two sides being thermally coupled to facilitate heat transfer therebetween. Although illustrated as a plate and frame heat exchanger, the economizer 110 may be any other type of heat exchange device, such as, for example, a shell and tube heat exchanger or other device.

The evaporator 115, also illustrated as a plate and frame heat exchanger, receives the working fluid 101 from the surge vessel 125 at one side and receives a supply thermal fluid 190 at another side, with the two sides of the evaporator 115 being thermally coupled to facilitate heat exchange between the thermal fluid and working fluid 101. For instance, the working fluid 101 enters the evaporator 115 from the economizer 110 in liquid phase and is changed to a vapor phase by heat exchange with the thermal fluid supply 190. Although illustrated as a plate and frame heat exchanger, the evaporator 115 may be any other type of heat exchange device, such as, for example, a shell and tube heat exchanger or other device.

Power generation system 100 includes one or more turbine expanders 120, which receive the working fluid 101 (in vapor phase) from the surge vessel 125 and are driven by the working fluid 101 to produce AC current. As illustrated, three turbine expanders 120 are connected in parallel with the working fluid 101 being supplied to the expanders 120 from a supply header 147 through control valves 145. The working fluid 101 is exhausted from the expanders 120 into an exhaust header 143 through isolation valves 160. In some embodiments, each turbine expander 120 may be a microturbine capable of rotating at rotational speeds up to 26,500 rpm to drive a generator (as a component of or electrically coupled to the turbine expander 120) producing up to 125 kW AC power. In some embodiments, each control valve 145 is a three-way modulating control valve, which is in fluid communication with a bypass conduit (not shown) that bypasses the turbine expander 120 and allows the working fluid 101 to be circulated to the exhaust header 143 without driving the turbine expander 120.

The surge vessel 125 is in fluid communication with the evaporator 115 and separates working fluid 101 in liquid phase from working fluid 101 in vapor phase to ensure that the evaporator 115 is flooded with working fluid 101. In some embodiments, the pump 105 modulates flow of working fluid 101 to maintain a predetermined or calculated level of working fluid 101 (as liquid) in the surge vessel 125. For instance, a liquid level sensor may be included in the evaporator 115 and an output signal from the sensor may be used to modulate the flow of working fluid 101 (e.g., through pump speed, valve control, or other modulation techniques).

The condenser 130 receives the working fluid 101 (in vapor phase) from the economizer 110 and facilitates heat transfer with the working fluid 101 so as to induce a phase change to a liquid phase of the working fluid 101. As illustrated, the condenser 130 includes one or more fans 140 that drive air (or other gas) through the condenser 130 to facilitate convective heat transfer with the working fluid 101 (as a vapor). Alternatively, the condenser 130 may utilize other heat transfer techniques, such as water or liquid cooling. In a power generation system 100 utilizing R245fa as the working fluid 101, the condenser 130 may operate at 95° F. condensing temperature with a saturation pressure of 30.71 psia

The receiver 135 is in fluid communication with the condenser 130 and captures and consolidates the working fluid 101 (in liquid phase) output from the condenser 130. The working fluid 101 drains from the receiver 135 to the pump 105.

Turning particularly to FIGS. 1B and 1D-E, a thermal fluid pump 170 is illustrated as fluidly coupled to one side of the evaporator 115 and the supply thermal fluid 195. The pump 170 circulates the supply thermal fluid 195 into the evaporator 115, where heat is transferred from the fluid 195 to the working fluid 101. The thermal fluid is circulated our of the evaporator 115 as the return thermal fluid 185, which is at a lower temperature. In some instances, the thermal fluid may be heated from a waste heat source, such as boilers, engine exhaust, heat stacks, and flares burning landfill or digester gases.

The power electronics 155, in some embodiments, provide for electronic control of the power generation system 100 as well as power conversion. For example, the power electronics 155 may control the pumps 105 and 170, the control valves 145, each turbine expander 120, as well as other components of the power generation system 100. In addition, the power electronics 155 may receive a generated AC current from the turbine expander 120 (with generator) and convert the generated AC current (which may be at a high frequency) to a secondary AC current at a lower (e.g., grid) frequency. For example, power generated by operation of the turbine expanders 120 may be rectified to a DC power and then inverted into a usable AC power that is typically at 480 volts or 400 volts and 60 hertz or 50 hertz respectively. During such conversion, one or more switches (e.g., IGBT switches), which may not be perfectly efficient, generate heat energy in the power electronics 155. In some cases, this generated energy may be about 5 to 10% of the electrical power being converted into usable characteristics.

With reference to FIGS. 1A and 1C in particular, the cooling system 180 is illustrated in fluid communication with the outlet of the pump 105 and the power electronics 155, and the power electronics 155 and the inlet conduit of the condenser 130. As illustrated, the cooling system 180 is coupled to the power electronics 155 at a side panel of the power electronics 155. Alternatively, the cooling system 180 may be coupled to the power electronics 155 at, for example, a back panel, a top panel, a bottom panel, or other location. Typically, the cooling system 180 provides for a cooling source utilizing, for example, the working fluid 101 as a cooling medium to remove heat generated by and/or in the power electronics 155. For instance, in some cases, a throughput power of each turbine expander 120 is 100 kW and heat generated by electrical inefficiency is calculated to be 10 kW. This generated heat load, along with the known operating conditions of the condenser 130 (i.e., entering temperature and pressure of working fluid 101 in vapor phase), known operating conditions of the working fluid 101 circulated through the outlet of the pump 105 (i.e., leaving temperature and pressure of the working fluid 101 in liquid phase), as well as specific heat (Cₚ) and heat of vaporization (i.e., latent heat) of the working fluid 101, may be used to calculate a necessary mass flow rate of the working fluid 101. This mass flow rate may be calculated to maintain the power electronics 155 at a maximum temperature rating (e.g., 176° F. (80° C.)).

Typically (as explained in more detail below), the cooling system 180 includes a fitting tied into the outlet conduit of the pump 105, an isolation valve and throttling valve, and a conduit carrying the working fluid 101 to a heat sink in the power electronics 155. Cooling system 180 also includes a conduit carrying the working fluid 101 from the heat sink to the inlet conduit of the condenser through another isolation valve. The throttling valve that has a variable area adjustment to control flow. The throttling valve is used to limit the flow and will also drop the pressure in the flow before the power electronics 155. Typically, the connections at all points are leak free.

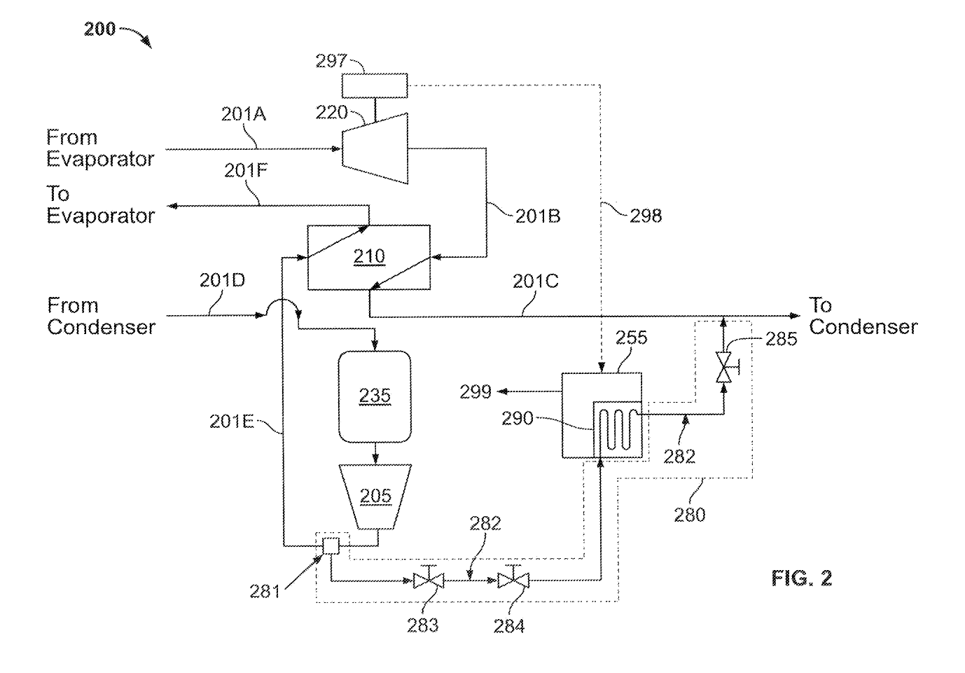

FIG. 2 illustrates one example process diagram showing one example operation of a power generation system 200 utilizing a cooling system 280. Power generation system 200 includes a working fluid pump 205, an economizer 210, a turbine expander 220 coupled to a generator 297, a receiver 235, power electronics 255, and a cooling system 280. A working fluid 201 circulates through the components of power generation system 200 in a thermodynamic cycle (e.g., a closed Rankine cycle) to drive the turbine expander 220 and generate AC power 298 by the generator 297. Generally, the cooling system 280 may operate to dissipate heat generated in the power electronics 255 in, for example, rectifying and/or converting the AC power 298 to a second AC power 299. AC power 299 may be at a lower frequency, a lower voltage, or both a lower frequency and voltage relative to AC power 298. For instance, AC power 299 may be suitable for supplying to a grid operating at 60 Hz and between 400-480V or a grid operating at 50 Hz at other voltages.

In operation, power generation system 200 circulates a working fluid 201A through the turbine expander 220 to drive (i.e., rotate) the turbine expander 220, which may be a microturbine. Working fluid 201A is typically in vapor phase at a high temperature and pressure (e.g., 200° F. and at or above 150 psig). Turbine expander 220 drives the generator 297 which generates AC power 298. A working fluid 201B exhausts from the turbine expander 220 and, typically, is in vapor phase at a relatively lower temperature and pressure.

Working fluid 201B enters the economizer 210 where heat energy is transferred thereto from a working fluid 201E. Working fluid 201E, typically, is in liquid phase at high temperature and pressure (e.g., 95° F. and about 225 psia). Subsequent to passing through the economizer 210 after the turbine expander 220, the working fluid 201 exits to a condenser (not shown) as working fluid 201C. Working fluid 201C, like working fluid 201B, is in vapor phase but at a higher temperature and pressure as compared to working fluid 201B, having gained heat energy in the economizer 210. Working fluid 201 returns from the condenser as working fluid 201D. Working fluid 201D is, typically, in liquid phase, having undergone a phase change from vapor to liquid in the condenser by, for example, convective heat transfer with a cooling medium (e.g., air or other gas or fluid). In some embodiments, the condenser is operating at 95° F. condensing temperature with a saturation pressure of 30.71 psia.

Working fluid 201D enters the receiver 235 where, for example, multiple streams of working fluid 201D may be collected and/or consolidated from the condenser. The working fluid 201D then is pressurized by the pump 205 to working fluid 201E. In some implementations, working fluid 201E, which is in liquid phase, is at a 95° F. and about 225 psia. Working fluid 201E is circulated to the economizer 210, where heat therefrom is transferred to the working fluid 201B (e.g., from the hot side to the cold side of the economizer 210). Working fluid 201F exits the economizer 210 in liquid phase and is circulated to an evaporator (not shown), thereby completing or substantially completing the thermodynamic cycle.

The cooling system 280 receives a portion of the working fluid 201E through a fitting 281 (e.g., a “T”) and into a conduit 282 (e.g., ½″ conduit). The conduit 282 communicates the working fluid 201E therein through an isolation valve 283 and an expansion valve 284 (e.g., a ball valve, globe valve, or other modulating valve) and to a heat exchanger 290 (e.g., a heat sink) of the power electronics 255. In some aspects, the expansion valve 284 may include an actuator (e.g., hydraulic, pneumatic, electronic, electro-mechanical, or other type of actuator). The actuator (not shown), may receive one or more signals representative of one or more properties of the working fluid 201 (e.g., pressure, temperature, or other property) and modulate the valve 284 based on the one or more signals. For instance, a temperature sensor may monitor a temperature of the working fluid 201 exiting the heat exchanger and, based on, for example, a rise in the temperature above a predetermined value, modulate the valve 284 to allow more flow of the working fluid 201 through the valve 284 and to the heat exchanger 290. In some instances, the valve 284 may be modulated to multiple positions, for example, 10% open, 25% open, 50% open, and other percentages, including fully closed and fully open.

In some embodiments, the power electronics 255 may include one or more switches (e.g., IGBT switches) that generate heat and are thermally coupled to the heat exchanger 290. Heat is transferred, via the heat exchanger 290, from the power electronics 255 to the working fluid 201E such that, for example, the working fluid 201E changes from liquid to vapor phase at or about 95° F. and about 30.7 psia. For instance, heat transferred in the heat exchanger 290 may be substantially equal to a latent heat of vaporization of the working fluid 201. The working fluid 201E is then circulated through the conduit 282 to merge and/or combine with the working fluid 201C which is circulated to the condenser. In some instances, an isolation valve 285 is placed (along with isolation valve 283) so that the cooling system 280 may be isolated, such as, for example, repair or servicing. In some embodiments, the expansion valve 284 may be throttled to control a flow rate of the working fluid 201E through the conduit 282 such that working fluid 201E vaporizes to match the conditions of working fluid 201C circulated to the condenser.

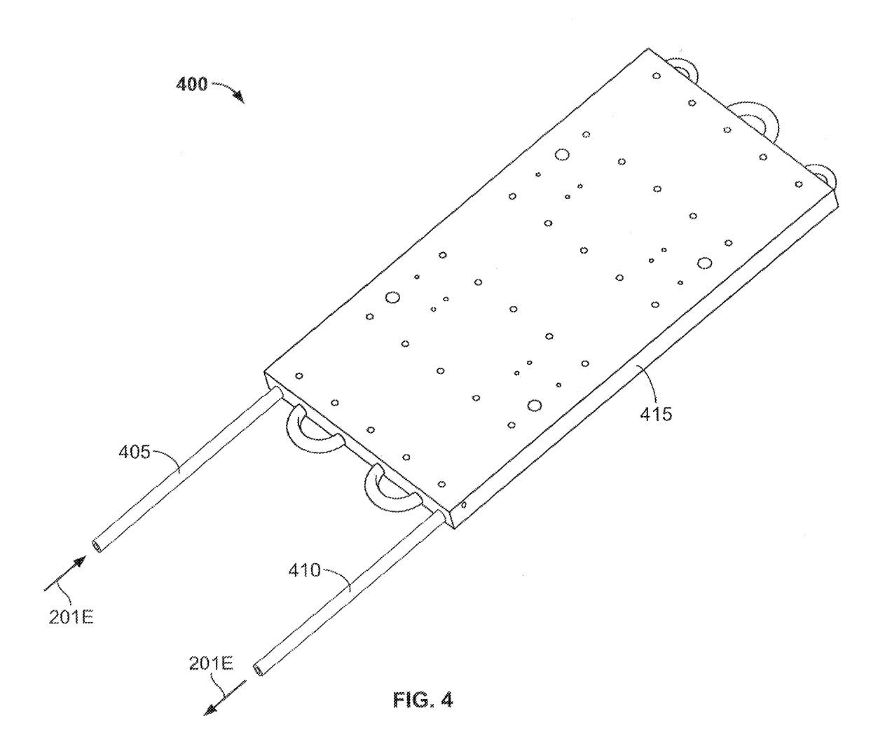

Turning briefly to FIG. 4, one example implementation of a heat exchanger 400 is illustrated. In some embodiments, heat exchanger 400 may implemented as heat exchanger 290 shown in FIG. 2. Heat exchanger 400, as illustrated, is a heat sink, such that heat generated within and/or by the power electronics 255 (such as by one or more switches) is transferred to a solid portion 415 of the heat exchanger 400. Such heat may then be transferred to a fluid (e.g., working fluid 201E) circulated through from a fluid inlet 405 to and through a fluid outlet 410. For example, one or more switches and/or other heat generating components of the power electronics 255 may be thermally coupled to the heat exchanger 400 by, for instance, conductive contact. In operation, heat generated by the switches and/or other heat generating components may flow to the solid portion 415 of the heat exchanger 400 and then to the working fluid 201E circulated through one or more fluid circuits disposed within and in contact with the solid portion 415. In some embodiments, the working fluid 201E entering the fluid inlet 405 may be substantially liquid while the working fluid 201E exiting the fluid outlet 410 may be partially, completely, or mostly vapor.

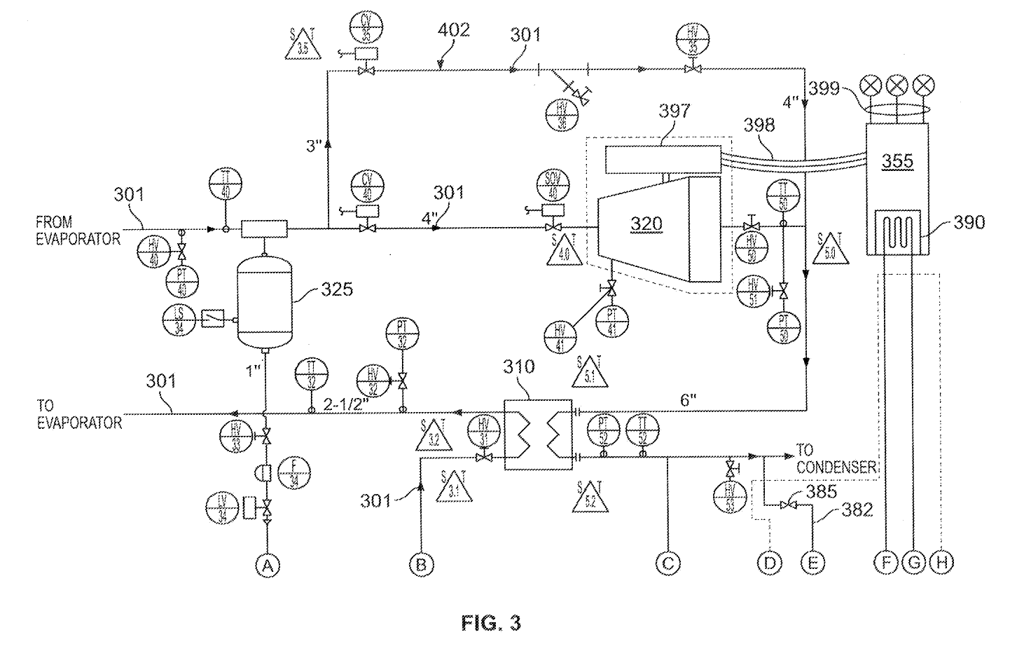

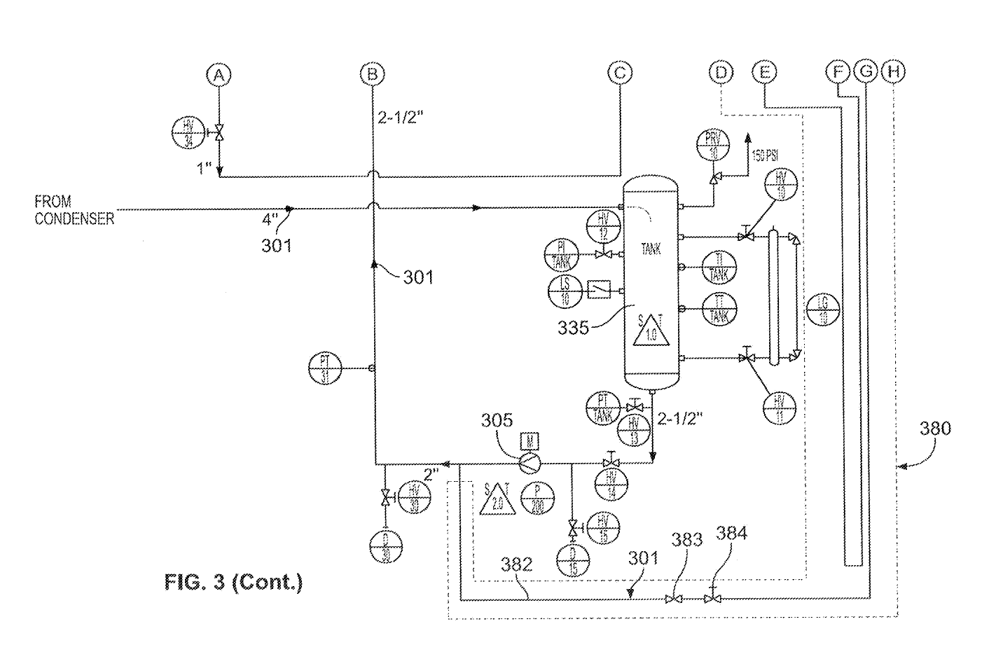

FIG. 3 illustrates another example process diagram showing one example operation of a power generation system 300 utilizing a cooling system 380. As illustrated, the process diagram of FIG. 3 may include more detail and show more components (e.g., sensors such as temperature and pressure sensors or transducers (“PT” and “TT”); valves such as control valves (“CV”), solenoid operated valves (“SOV”) and hand valves (“HV”); fittings; or other components) as compared to FIG. 2. Power generation system 300 includes a working fluid pump 305, an economizer 310, a turbine expander 320 coupled to a generator 397, a receiver 335, power electronics 355, and a cooling system 380. A working fluid 301 circulates through the components of power generation system 300 in a thermodynamic cycle (e.g., a closed Rankine cycle) to drive the turbine expander 320 and generate AC power 398 by the generator 397. Generally, the cooling system 380 may operate to dissipate heat generated in the power electronics 355 in, for example, rectifying and/or converting the AC power 398 to a second AC power 399. AC power 399 may be at a lower frequency, a lower voltage, or both a lower frequency and voltage relative to AC power 398. For instance, AC power 399 may be suitable for supplying to a grid operating at 60 Hz and between 400-480V.

System 300 also includes a surge vessel 325 in fluid communication with the evaporator and separates working fluid 301 in liquid phase from working fluid 301 in vapor phase to ensure that the evaporator is flooded with working fluid 301. A liquid level sensor may be included in the evaporator and an output signal from the sensor may be used to modulate the flow of working fluid 301 (e.g., through pump speed, valve control, or other modulation techniques).

In operation, power generation system 300 circulates a working fluid 301 through the turbine expander 320 to drive (i.e., rotate) the turbine expander 320, which may be a microturbine. Turbine expander 320 drives the generator 397 which generates AC power 398. The working fluid 301 exhausts from the turbine expander 320 and, typically, is in vapor phase at a relatively lower temperature and pressure.

Working fluid 301 enters the economizer 310 at both sides of the economizer 310 (i.e., the hot and cold sides) where heat energy is transferred from the hot side working fluid 301 (i.e., liquid phase) to the cold side working fluid 301 (i.e., vapor phase). The working fluid 301 exits the cold side of the economizer 310 to a condenser (not shown) at vapor. The working fluid 301 returns from the condenser in liquid phase, having undergone a phase change from vapor to liquid in the condenser by, for example, convective heat transfer with a cooling medium (e.g., air or other gas).

The working fluid 301 returned from the condenser enters the receiver 335 and is then pressurized by the pump 305. The working fluid 301 is then circulated to the hot side of the economizer 310, where heat therefrom is transferred to the working fluid 301 (e.g., from the hot side to the cold side of the economizer 310). Working fluid 301 exits the hot side of the economizer 310 in liquid phase and is circulated to an evaporator (not shown), thereby completing or substantially completing the thermodynamic cycle.

In the illustrated embodiment, the power generation system 300 includes a bypass 402, which allows vapor working fluid 301 to bypass the turbine expander 320 and merge into an exhaust of the turbine expander 320. In some embodiments, this may allow for better and/or more exact control of the power generation system 300 and, more particularly, to, for example, maintain an optimum speed of the turbine expander 320.

The cooling system 380 receives a portion of the working fluid 301 and into a conduit 382. The conduit 382 communicates the working fluid 301 therein through an isolation valve 383 and an expansion valve 384 and to a heat exchanger 390 (e.g., a heat sink) of the power electronics 355. For example, the power electronics 355 may include one or more switches (e.g., IGBT switches) that generate heat and are thermally coupled to the heat exchanger 390. Heat is transferred, via the heat exchanger 390, from the power electronics 355 to the working fluid 301 such that, for example, the working fluid 301 changes from liquid to vapor phase. For instance, heat transferred in the heat exchanger 390 may be substantially equal to a heat of vaporization of the working fluid 301. The working fluid 301 is then circulated through the conduit 382 to merge and/or combine with the working fluid 301 which is circulated to the condenser. In some instances, an isolation valve 385 is placed (along with isolation valve 383) so that the cooling system 380 may be isolated, such as, for example, repair or servicing. In some embodiments, the expansion valve 384 may be throttled to control a flow rate of the working fluid 301 through the conduit 382 such that working fluid 301 vaporizes to match the conditions (e.g., temperature and pressure) of the working fluid 301 circulated to the condenser.

A number of implementations have been described. Nevertheless, it will be understood that various modifications may be made. Accordingly, other implementations are within the scope of the following claims.

What is claimed is:

1. A system, comprising:
a working fluid operable to be circulated through a working cycle, the working cycle comprising:
one or more expander-generators driven by the working fluid to generate electrical power at a first condition;
an evaporator heat exchanger; and
a condenser heat exchanger;
power electronics thermally coupled to a heat exchanger and adapted to convert the electrical power at the first condition to electrical power at a second condition; and
a conduit in fluid communication with the working cycle and the heat exchanger, the conduit adapted to circulate the working fluid through the heat exchanger such that heat generated by the power electronics is transferred to the working fluid.

2. The system of claim 1, wherein the working cycle comprises a closed thermodynamic cycle.

3. The system of claim 2, wherein the closed thermodynamic cycle comprises an organic Rankine cycle.

4. The system of claim 1, wherein the heat transferred to the working fluid in the heat exchanger is substantially equal to a heat of vaporization of the working fluid.

5. The system of claim 1, wherein the working cycle further comprises an economizer heat exchanger adapted to facilitate heat transfer between the working fluid exhausted from the one or more expander-generators and the working fluid exiting the condenser heat exchanger.

6. The system of claim 5, wherein the working fluid exhausted from the one or more expander-generators comprises a vapor and the working fluid exiting the condenser heat exchanger comprises a liquid.

7. The system of claim 5, wherein the working cycle further comprises a pump adapted to circulate the working fluid through at least a portion of the working cycle, and
wherein the conduit is fluidly coupled to the heat exchanger and the working cycle between an outlet of the pump and the economizer, the conduit fluidly coupled to the heat exchanger and the working cycle between the economizer and the condenser.

8. The system of claim 1 further comprising one or more isolation valves adapted to fluidly isolate the conduit from the working cycle.

9. The system of claim 1 further comprising an expansion valve including an actuator fluidly coupled to the conduit, wherein the actuator is adapted to modulate the expansion valve based on the heat generated by the power electronics.

10. The system of claim 1 further comprising a valve fluidly coupled to the conduit, wherein the valve is adapted to provide a predetermined flow rate of the working fluid through the conduit and to the heat exchanger based on a predetermined amount of heat generated by the power electronics.

11. The system of claim 1, wherein the power electronics comprise one or more switches, the switches adapted to receive the electrical power at the first condition and convert the electrical power at the first condition to the electrical power at the second condition, the second condition comprising three-phase AC power at substantially 60 Hz frequency.

12. A method, comprising:
circulating a working fluid through a working cycle, the working cycle comprising:
one or more expander-generators driven by the working fluid to generate electrical power at a first condition;
an evaporator heat exchanger; and
a condenser heat exchanger;
circulating at least a portion of the working fluid through a conduit in fluid communication with the working cycle and a heat exchanger, the heat exchanger thermally coupled to power electronics adapted to convert the electrical power at the first condition to electrical power at a second condition; and
transferring heat generated by the power electronics to the portion of the working fluid in the heat exchanger.

13. The method of claim 12, wherein the working cycle comprises an organic Rankine cycle.

14. The method of claim 12 further comprising:
circulating a first portion of the working fluid in a vapor phase into a hot side of an economizer;
circulating a second portion of the working fluid in a liquid phase into a cold side of the economizer; and
transferring heat from the first portion of the working fluid to the second portion of the working fluid.

15. The method of claim 14, further comprising:
pumping at least some of the working fluid through the working cycle with a pump;
circulating, from a location in the working cycle between an outlet of the pump and the cold side of the economizer, the portion of the working fluid through a conduit to the heat exchanger; and
circulating the portion of the working fluid through the conduit from the heat exchanger to a location in the working cycle between the hot side of the economizer and the condenser.

16. The method of claim 12 further comprising fluidly isolating the conduit and the heat exchanger from the working cycle.

17. The method of claim 12 further comprising throttling a flow of the portion of the working fluid circulated through the conduit with a valve between an open position and a closed position based on an amount of heat generated by the power electronics.

18. The method of claim 12, further comprising:
rectifying the electrical power at a first condition from AC power to DC power; and
inverting the DC power to electrical power at a second condition, the second condition comprising three-phase AC power at substantially 60 Hz frequency.

19. A method comprising:
generating electrical power with one or more turbine-generators driven by a Rankine cycle fluid;
converting the electrical power to a line current comprising three-phase current at a frequency between approximately 50 Hz and approximately 60 Hz;
generating, during the conversion of the electrical power, heat energy; and
transferring the heat energy to the fluid.

20. The method of claim 19, wherein transferring the heat energy to the fluid comprises:
circulating a flow of the fluid to a heat exchanger in thermal communication with one or more electronic switches performing the conversion of the electrical power to the line current;
monitoring a property of the fluid at or near the heat exchanger; and
modulating the flow of the fluid based on the property exceeding a predetermined value.

21. The method of claim 19, further comprising:
calculating an amount of the heat energy based on an efficiency of one or more electronic switches performing the conversion of the electrical power to the line current; and
circulating a mass flow of the fluid to a heat exchanger in thermal communication with the one or more electronic switches,
wherein a heat of vaporization of the mass flow of the fluid is substantially equal to the calculated amount of heat energy.
